(19) United States
(12) Patent Application Publication
(10) Pub. No.: US 2020/0328681 A1
(43) Pub. Date: Oct. 15, 2020

(54) BUCK-BOOST SWITCHING REGULATOR AND REGULATING METHOD THEREOF

(71) Applicant: REALTEK SEMICONDUCTOR CORP., Hsinchu (TW)

(72) Inventors: Wei-Wen Ou, Hsinchu (TW); Shih-Chieh Chen, Hsinchu (TW); Chien-Sheng Chen, Hsinchu (TW); Hung-Hsuan Cheng, Hsinchu (TW)

(73) Assignee: REALTEK SEMICONDUCTOR CORP., Hsinchu (TW)

(21) Appl. No.: 16/845,421

(22) Filed: Apr. 10, 2020

(30) Foreign Application Priority Data
Apr. 11, 2019 (TW) 108112763

(51) Int. Cl. H02M 3/158

(52) U.S. Cl. CPC H02M 3/1582

(57) ABSTRACT

A buck-boost switching regulating method includes outputting a mode signal according to an input voltage and an output voltage, generating one of a plurality of triangle waves according to the mode signal, comparing a feedback signal and a reference signal to generate an error signal, comparing the error signal and the generated triangle wave to output a comparison signal, and generating a set of switch signals according to the comparison signal. The feedback signal is related to the output voltage. The waveform of the triangle wave generated when the mode signal represents a buck-boost mode is larger than that when the mode signal represents a adjusting mode.

### CROSS-REFERENCE TO RELATED APPLICATION

This non-provisional application claims priority under 35 U.S.C. § 119(a) to Patent Application No. 108112763 in Taiwan, R.O.C. on Apr. 11, 2019, the entire contents of which are hereby incorporated by reference.

### BACKGROUND

### Technical Field

The present invention relates to a buck-boost control mechanism, and in particular, to a buck-boost switching regulator and a regulating method thereof.

### Related Art

Voltage conversion circuits are commonly found in electronic apparatuses, and provide voltages required by loads by boosting or bucking input voltages. In a voltage conversion circuit, a buck-boost converter can provide stable output voltages within a relatively broad voltage variation range.

A buck-boost converter converts an input voltage into an output voltage through switching of four power switches, energy storage of an inductor, and filtering of a capacitor. For a relatively broad voltage variation range, the buck-boost converter may have a boost conversion mode, a pure buck conversion mode, and a boost-buck conversion mode.

A control mechanism of a common buck-boost converter is comparing, by using two comparators, an external error separately with two triangle waves that have a same waveform, but have different levels, to obtain switch control signals of four power switches. When the external error is between lower peak levels of the two triangle waves, the buck-boost converter is in a pure buck conversion mode. When the external error is between upper peak levels of the two triangle waves, the buck-boost converter is in a boost conversion mode. When the external error is between a lower peak level of a triangle wave having a high level and an upper peak level of a triangle wave having a low level, the buck-boost converter is in a buck-boost conversion mode.

### SUMMARY

However, a control circuit of a buck-boost converter is complex in terms of design, and noise of an output voltage in a buck-boost conversion mode is relatively large.

In view of the above, the present invention provides a buck-boost switching regulator and a regulating method thereof, where amplified and down-converted triangle waves are used in a buck-boost mode as comparison bases to obtain states of power switches, so that linear output can be achieved, to prevent a control mechanism from jumping back and forth between bucking and boosting, thereby reducing noise generated in an output voltage.

In an embodiment, a buck-boost switching regulator is provided, including a mode detection circuit, a waveform generator, an error amplifier, a comparator, a pulse width modulation circuit. The mode detection circuit outputs a mode signal according to an input voltage and an output voltage. The waveform generator outputs one of a plurality of triangle waves according to the mode signal. The error amplifier compares a feedback signal and a reference signal to generate an error signal. Herein, the feedback signal is related to the output voltage. The comparator compares the error signal and the triangle wave output by the waveform generator to output a comparison signal. The pulse width modulation circuit generates a set of switch signals according to the comparison signal. The waveform of the triangle wave output by the waveform generator when the mode signal represents a buck-boost mode is larger than the waveform of the triangle wave output by the waveform generator when the mode signal represents a adjusting mode.

In an embodiment, a buck-boost switching regulating method is provided, including: outputting a mode signal according to an input voltage and an output voltage, generating one of a plurality of triangle waves according to the mode signal, comparing a feedback signal and a reference signal to generate an error signal, comparing the error signal and the generated triangle wave to output a comparison signal; and generating a set of switch signals according to the comparison signal. The feedback signal is related to the output voltage. The waveform of the triangle wave output when the mode signal represents a buck-boost mode is larger than the waveform of the triangle wave output when the mode signal represents a adjusting mode.

### BRIEF DESCRIPTION OF THE DRAWINGS

FIG. 1 is a schematic diagram of a buck-boost switching regulator according to an embodiment of the present invention.

FIG. 2 is a flowchart of a buck-boost switching regulating method according to an embodiment of the present invention.

FIG. 3 is a timing diagram of respective signals of an example.

FIG. 4 and FIG. 5 are schematic diagrams of performing a buck operation by a voltage conversion circuit of an example.

FIG. 6 and FIG. 7 are schematic diagrams of performing a boost operation by a voltage conversion circuit of an example.

FIG. 8 is a schematic diagram of an example of a mode detection circuit in FIG. 1.

### DETAILED DESCRIPTION

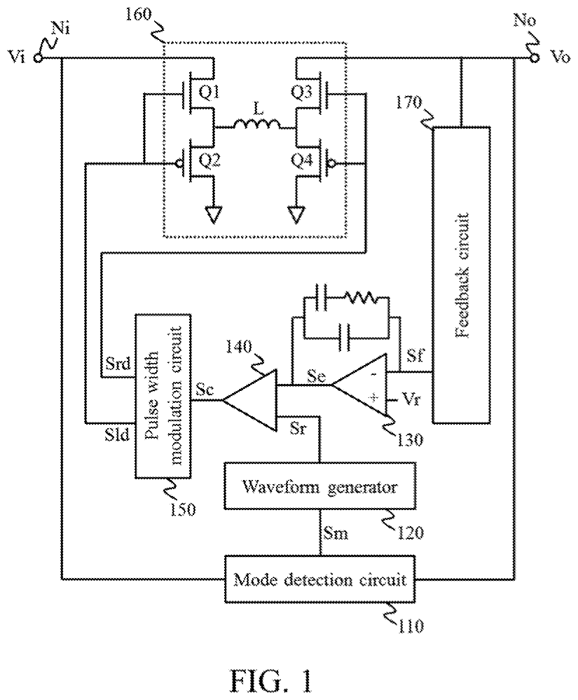

Referring to FIG. 1, a buck-boost switching regulator includes: a mode detection circuit 110, a waveform generator 120, an error amplifier 130, a comparator 140, and a pulse width modulation (PWM) circuit 150. The waveform generator 120 is coupled between a first input terminal of the comparator 140 and the mode detection circuit 110. A second input terminal of the comparator 140 is coupled to an output terminal of the error amplifier 130. An output terminal of the comparator 140 is coupled to a control terminal of the PWM circuit 150. In some embodiments, the buck-boost switching regulator may further include: a voltage conversion circuit 160. The voltage conversion circuit 160 is coupled between a voltage input terminal Ni and a voltage output terminal No. An output terminal of the PWM circuit 150 is coupled to a control terminal of the voltage conversion circuit 160.

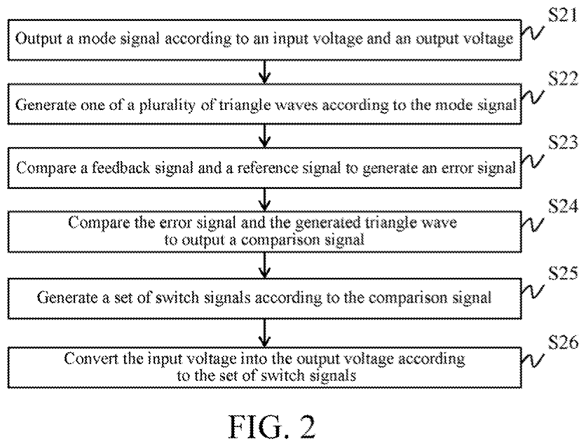

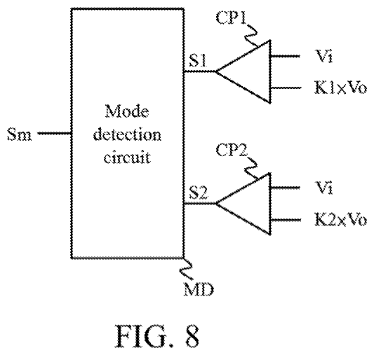

Referring to FIG. 1 and FIG. 2, the mode detection circuit 110 outputs a mode signal Sm according to an input voltage Vi and an output voltage Vo (step S21). In some embodiments, the mode detection circuit 110 compares the input voltage Vi and the output voltage Vo for a relationship therebetween to learn of an operation mode of the voltage conversion circuit 160, thereby outputting the mode signal Sm representing a current operation mode. The operation mode of the voltage conversion circuit 160 includes a buck-boost mode (for example, a buck-boost conversion mode) and a adjusting mode (for example, a buck conversion mode or a boost conversion mode). In an example, the mode detection circuit 110 may receive and detect the input voltage Vi and the output voltage Vo and accordingly, learn of the current operation mode of the voltage conversion circuit 160, as shown in FIG. 1. In another example, referring to FIG. 8, the mode detection circuit 110 may receive and detect a feedback signal of the input voltage Vi (for example, a partial voltage of the input voltage Vi) and a feedback signal of the output voltage Vo (for example, a partial voltage of the output voltage Vo), and accordingly, learn of the current operation mode of the voltage conversion circuit 160. In another example, the feedback signal of the input voltage Vi and the output voltage Vo, or the input voltage Vi and the feedback signal of the output voltage Vo are detected to accordingly learn of the current operation mode of the voltage conversion circuit 160.

In some embodiments, the waveform generator 120 receives the mode signal Sm and outputs one triangle wave Sr of a plurality of triangle waves according to the mode signal Sm (step S22). The waveform of the triangle wave Sr output by the waveform generator 120 when the mode signal Sm represents the buck-boost mode (that is, the voltage conversion circuit 160 currently executes the buck-boost mode) is larger than the waveform of the triangle wave Sr output by the waveform generator 120 when the mode signal Sm represents the adjusting mode (that is, the voltage conversion circuit 160 currently executes the adjusting mode). Herein, triangle waves corresponding to different operation modes are different from each other (for example, frequencies are different or levels are different). In some embodiments, bevels of the triangle waves corresponding to different operation modes may have slopes that are substantially the same.

A first input terminal of the error amplifier 130 receives a feedback signal Sf, and a second input terminal of the error amplifier 130 receives a reference signal Vr. The error amplifier 130 compares the feedback signal Sf and the reference signal Vr, and generates an error signal Se according to a comparison result of the feedback signal Sf and the reference signal Vr (step S23). The feedback signal Sf is related to the output voltage Vo. The reference signal Vr is a constant voltage from a voltage source. In some embodiments, the buck-boost switching regulator may further include a feedback circuit 170, where the feedback circuit 170 is coupled between the voltage output terminal No and the first input terminal of the error amplifier 130. The feedback signal Sf may be generated by the feedback circuit 170 by capturing the output voltage Vo. In an example, the feedback circuit 170 may include a voltage division circuit and divide the output voltage Vo to generate the feedback signal Sf. In an example, the feedback circuit 170 may include a voltage division circuit. The voltage division circuit is coupled between the voltage output terminal No and a grounding component, and a voltage division point of the voltage output terminal No (having the feedback signal Sf) is coupled to the first input terminal of the error amplifier 130 (error compensator), to enable the comparator 140 to accordingly output the error signal Se.

A first input terminal of the comparator 140 receives the triangle wave Sr output by the waveform generator 120, and a second input terminal of the comparator 140 receives the error signal Se. Herein, the comparator 140 may compare the received error signal Se and the received triangle wave Sr, and generate a comparison signal Sc according to a comparison result of the error signal Se and the triangle wave Sr (step S24).

The PWM circuit 150 receives the comparison signal Sc, and generates a set of switch signals Srd and Sld according to the comparison signal Sc (step S25). In some embodiments, the PWM circuit 150 may be implemented as a logic circuit.

The voltage conversion circuit 160 receives the input voltage Vi, and converts the input voltage Vi into the output voltage Vo according to the switch signals Srd and Sld (step S26).

In some embodiments, the voltage conversion circuit 160 may include four power switches Q1, Q2, Q3, and Q4 and an inductor L. A first terminal of the power switch Q1 is coupled to a voltage input terminal Ni, and a second terminal of the power switch Q1 is coupled to a first terminal of the power switch Q2 and a first terminal of the inductor L. A second terminal of the power switch Q2 is coupled to a grounding component. A first terminal of the power switch Q3 is coupled to the voltage output terminal No, and a second terminal of the power switch Q3 is coupled to a first terminal of the power switch Q4 and a second terminal of the inductor L. A second terminal of the power switch Q4 is coupled to the grounding component. Control terminals of the four power switches Q1, Q2, Q3, and Q4 are coupled to the output terminal of the PWM circuit 150. The power switch Q1 is controlled by the switch signal Sld, and the power switch Q2 is controlled by a reverse switch signal Sld. The power switch Q3 is controlled by the switch signal Srd, and the power switch Q4 is controlled by a reverse switch signal Srd.

In some embodiments, the adjusting mode may include a buck conversion mode M1 and a boost conversion mode M2. The buck-boost mode may include a buck-boost conversion mode M3. In an example, when the input voltage Vi is greater than the output voltage Vo, the voltage conversion circuit 160 executes the buck conversion mode M1 in response to the switch signals Srd and Sld. When the input voltage Vi is less than the output voltage Vo, the voltage conversion circuit 160 executes the boost conversion mode M2 in response to the switch signals Srd and Sld. When the input voltage Vi is equal to (or is similar to) the output voltage Vo, the voltage conversion circuit 160 executes the buck-boost conversion mode M3 in response to the switch signals Srd and Sld.

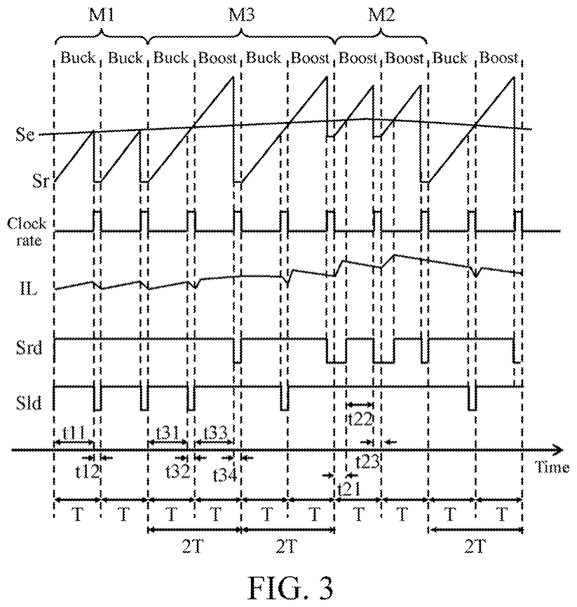

FIG. 3 is a timing diagram of respective signals including an error signal Se, a triangle wave Sr output by the waveform generator 120, a current signal IL of an inductor L, and switch signals Srd and Sld.

Referring to FIG. 1 and FIG. 3, a voltage difference between a wave peak and a wave trough that are of the triangle wave Sr output by the waveform generator 120 when the mode signal Sm represents the buck-boost conversion mode M3 may be approximately two times a voltage difference between a wave peak and a wave trough that are of the triangle wave Sr output by the waveform generator 120 when the mode signal Sm represents the buck conversion mode M1 or the boost conversion mode M2.

In an example, the waveform of the triangle wave Sr output by the waveform generator 120 when the mode signal Sm represents the buck conversion mode M1 is the same as the waveform of the triangle wave Sr output by the waveform generator 120 when the mode signal Sm represents the boost conversion mode M2, but the two triangle waves Sr have different levels. In other words, a voltage difference between a wave peak and a wave trough that are of the triangle wave Sr in the buck conversion mode M1 is substantially the same as a voltage difference between a wave peak and a wave trough that are of the triangle wave Sr in the boost conversion mode M2. The level of the triangle wave Sr when the mode signal Sm represents the buck conversion mode M1 is lower than the level of the triangle wave Sr when the mode signal Sm represents the boost conversion mode M2. Herein, the amplitude of the triangle wave Sr output by the waveform generator 120 when the mode signal Sm represents the buck-boost mode is a sum of the amplitude of the triangle wave Sr output when the mode signal Sm represents the buck conversion mode M1 and the amplitude of the triangle wave Sr output when the mode signal Sm represents the boost conversion mode M2. In other words, the triangle wave Sr when the mode signal Sm represents the buck-boost conversion mode M3 is equivalent to superposition of the triangle wave Sr when the mode signal Sm represents the buck conversion mode M1 and the triangle wave Sr when the mode signal Sm represents the boost conversion mode M2.

In an embodiment, the frequency of the triangle wave Sr output by the waveform generator 120 when the mode signal Sm represents the buck-boost mode is less than the frequency of the triangle wave Sr output by the waveform generator 120 when the mode signal Sm represents the adjusting mode. For example, the frequency of the triangle wave Sr when the mode signal Sm represents the buck-boost conversion mode M3 may be 1/2T, and the frequency of the triangle wave Sr when the mode signal Sm represents the buck conversion mode M1 or the boost conversion mode M2 may be 1/T. That is, the frequency of the triangle wave Sr when the mode signal Sm represents the buck-boost conversion mode M3 is a half of the frequency of the triangle wave Sr when the mode signal Sm represents the buck conversion mode M1 or the boost conversion mode M2.

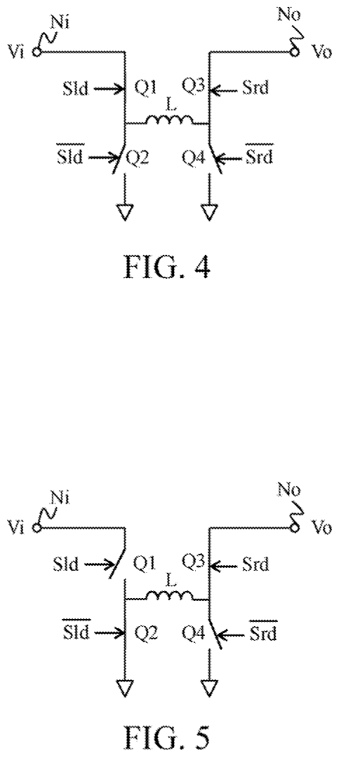

Waveforms of respective signals shown in FIG. 3 are used as an example. In the buck conversion mode M1, in an interval of a first time t11 of each period T, the power switches Q1 and Q3 are on, and the power switches Q2 and Q4 are off, as shown in FIG. 4; and in an interval of a second time t12 of each period T, the power switches Q2 and Q3 are on, and the power switches Q1 and Q4 are off, as shown in FIG. 5.

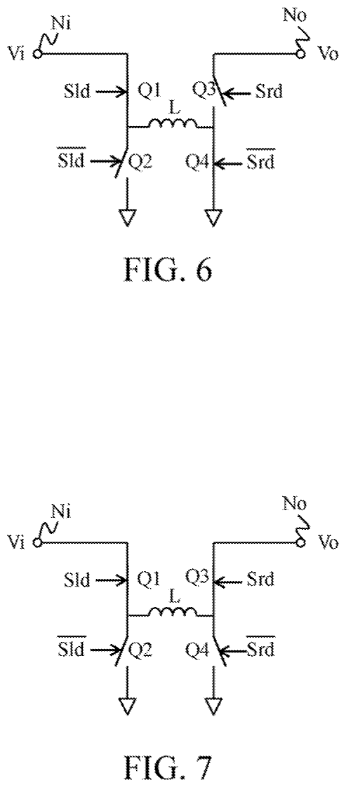

In the boost conversion mode M2, in intervals of a first time t21 and a third time t23 of each period T, the power switches Q1 and Q4 are on, and the power switches Q2 and Q3 are off, as shown in FIG. 6; and in an interval of a second time t22 of each period T, the power switches Q1 and Q3 are on, and the power switches Q2 and Q4 are off, as shown in FIG. 7.

In the buck-boost conversion mode M3, in intervals of a first time t31 and a third time t33 of each period 2T, the power switches Q1 and Q3 are on, and the power switches Q2 and Q4 are off, as shown in FIG. 4 and FIG. 6; in an interval of a second time t32 of each period 2T, the power switches Q2 and Q3 are on, and the power switches Q1 and Q4 are off, as shown in FIG. 5; and in an interval of a fourth time t34 of each period 2T, the power switches Q1 and Q4 are on, and the power switches Q2 and Q3 are off, as shown in FIG. 7.

In some embodiments, referring to FIG. 8, the mode detection circuit 110 may include two comparators CP1 and CP2 and a mode decision unit MD. Herein, the comparator CP1 receives the input voltage Vi and a first proportion K1 of the output voltage Vo, and accordingly, outputs a comparison signal Si to the mode decision unit MD. The comparator CP2 receives the input voltage Vi and a second proportion K2 of the output voltage Vo, and accordingly, outputs a comparison signal S2 to the mode decision unit MD. The mode decision unit MD decides a adjusting mode according to the received comparison signals Si and S2, outputs the corresponding mode signal Sm, and accordingly, controls an operation of the waveform generator 120. The first proportion K1 is different from the second proportion K2. Herein, the first proportion K1 may be greater than 50% and less than 100%, and the second proportion K2 may be greater than 100% and less than 150%. In an example, it is assumed that the first proportion K1 is 80%, and the second proportion K2 is 120%. When the input voltage Vi is greater than the first proportion K1 of the output voltage Vo, and the input voltage Vi is less than the second proportion K2 of the output voltage Vo (that is, Vi>80% Vo and Vi<120% Vo), the mode decision unit MD outputs the mode signal Sm representing the buck-boost conversion mode M3. When the input voltage Vi is greater than the first proportion K1 of the output voltage Vo, and the input voltage Vi is greater than the second proportion K2 of the output voltage Vo (that is, Vi>80% Vo and Vi>120% Vo), the mode decision unit MD outputs the mode signal Sm representing the buck conversion mode M1. When the input voltage Vi is less than the first proportion K1 of the output voltage Vo, and the input voltage Vi is less than the second proportion K2 of the output voltage Vo (that is, Vi<80% Vo and Vi<120% Vo), the mode decision unit MD outputs the mode signal Sm representing the boost conversion mode M2.

In conclusion, the buck-boost switching regulator and the regulating method thereof according to the present invention have various operation modes of voltage conversion, where amplified and down-converted triangle waves Sr are used in a buck-boost mode as comparison bases to obtain states of power switches Q1, Q2, Q3, and Q4, so that linear output can be achieved, to prevent a control mechanism from jumping back and forth between bucking and boosting, thereby reducing noise generated in an output voltage Vo. In an embodiment, in the buck-boost switching regulator and the regulating method thereof according to the present invention, switch signals Srd and Sld of the power switches Q1, Q2, Q3, and Q4 are generated by using a control mechanism having relatively simple circuit design. For example, during an actual execution process, each operation mode is comparing an external error (the error signal Se) with a single triangle wave Sr by using a single comparator 140, to obtain states of the power switches Q1, Q2, Q3, and Q4.

What is claimed is:

1. A buck-boost switching regulator, comprising:
a mode detection circuit, configured to output a mode signal according to an input voltage and an output voltage;
a waveform generator, configured to output one of a plurality of triangle waves according to the mode signal, wherein the waveform of the triangle wave output by the waveform generator when the mode signal represents a buck-boost mode is larger than the waveform of the triangle wave output by the waveform generator when the mode signal represents a adjusting mode;
an error amplifier, configured to compare a feedback signal and a reference signal to generate an error signal, wherein the feedback signal is related to the output voltage;
a comparator, configured to compare the error signal and the triangle wave output by the waveform generator to output a comparison signal; and
a pulse width modulation circuit, configured to generate a set of switch signals according to the comparison signal.

2. The buck-boost switching regulator according to claim 1, further comprising:
a voltage conversion circuit, configured to convert the input voltage into the output voltage according to the set of switch signals.

3. The buck-boost switching regulator according to claim 1, wherein bevels of the plurality of triangle waves have a same slope.

4. The buck-boost switching regulator according to claim 1, wherein the frequency of the triangle wave output by the waveform generator when the mode signal represents the buck-boost mode is a half of the frequency of the triangle wave output by the waveform generator when the mode signal represents the adjusting mode.

5. The buck-boost switching regulator according to claim 1, wherein the adjusting mode comprises a buck conversion mode and a boost conversion mode, and the amplitude of the triangle wave output by the waveform generator when the mode signal represents the buck-boost mode is a sum of the amplitude of the triangle wave output by the waveform generator when the mode signal represents the buck conversion mode and the amplitude of the triangle wave output by the waveform generator when the mode signal represents the boost conversion mode, and the level of the triangle wave when the mode signal represents the buck conversion mode is lower than the level of the triangle wave when the mode signal represents the boost conversion mode.

6. A buck-boost switching regulating method, comprising:
outputting a mode signal according to an input voltage and an output voltage;
generating one of a plurality of triangle waves according to the mode signal, wherein the waveform of the triangle wave generated when the mode signal represents a buck-boost mode is larger than the waveform of the triangle wave generated when the mode signal represents a adjusting mode;
comparing a feedback signal and a reference signal to generate an error signal, wherein the feedback signal is related to the output voltage;
comparing the error signal and the generated triangle wave to output a comparison signal; and
generating a set of switch signals according to the comparison signal.

7. The buck-boost switching regulating method according to claim 6, further comprising:
converting the input voltage into the output voltage according to the set of switch signals.

8. The buck-boost switching regulating method according to claim 6, wherein bevels of the plurality of triangle waves have a same slope.

9. The buck-boost switching regulating method according to claim 6, wherein in the step of generating the triangle wave, the frequency of the triangle wave when the mode signal represents the buck-boost mode is a half of the frequency of the triangle wave when the mode signal represents the adjusting mode.

10. The buck-boost switching regulating method according to claim 6, wherein the adjusting mode comprises a buck conversion mode and a boost conversion mode, in the step of generating the triangle wave, the amplitude of the triangle wave when the mode signal represents the buck-boost mode is greater than or equal to a sum of the amplitude of the triangle wave when the mode signal represents the buck conversion mode and the amplitude of the triangle wave when the mode signal represents the boost conversion mode, and the level of the triangle wave when the mode signal represents the buck conversion mode is lower than the level of the triangle wave when the mode signal represents the boost conversion mode.
